(19) United States
(12) Patent Application Publication
(10) Pub. No.: US 2012/0072989 A1
(43) Pub. Date: Mar. 22, 2012

(54) INFORMATION PROCESSING SYSTEM, MANAGEMENT APPARATUS, AND INFORMATION PROCESSING METHOD

(75) Inventors: Takanori Sakai, Kawasaki (JP); Kazuhide Imaeda, Kawasaki (JP); Hiroyuki Yamamoto, Kawasaki (JP)

(73) Assignee: FUJITSU LIMITED, Kawasaki (JP)

(21) Appl. No.: 13/306,435

(22) Filed: Nov. 29, 2011

Related U.S. Application Data
(63) Continuation of application No. PCT/JP2009/060078, filed on Jun. 2, 2009.

(51) Int. Cl. G06F 21/00

(52) U.S. Cl. 726/24

(57) ABSTRACT

In an information processing system, a management apparatus reads all data from a storage device connected to an information processing apparatus, and stores the data as one image file in a backup storage device. A virus detection apparatus performs a virus detection process on the image file stored in the backup storage device in response to a request from the management apparatus, and if a computer virus is detected, performs a virus removal process on the image file. When the virus removal process is completed, the management apparatus reads and writes the image file from the backup storage device back to the storage device.

This application is a continuing application, filed under 35 U.S.C. §111(a), of International Application PCT/JP2009/060078, filed on Jun. 2, 2009.

### FIELD

The embodiments discussed herein relate to an information processing system including an apparatus provided with a data backup function and an apparatus provided with a virus check function, a management apparatus provided with the data backup function, and an information processing method.

### BACKGROUND

Computer viruses cause a lot of damage, for example, such as unintentional information leakage from user computers. To guard against the computer viruses, many companies which have many personal computers (PCs) run virus check on each PC.

In general, a company installs antivirus software in all PCs for virus check, and it is users' task to scan the PCs for virus. However, it is not assured that all PCs are scanned without fail, and therefore this virus security may fail to protect against information leakage or other damage.

For example, a virus check imposes a heavy load on the Central Processing Unit (CPU) of a PC, requiring frequent data inputs and outputs on Hard Disk Drives (HDD). Therefore, the virus check significantly decreases user's work efficiency. Because of this, some users may deactivate the virus check functions of their PCs.

Further, it is desirable that, if a virus check detects a computer virus on a PC, this PC is disconnected from a network. However, users may not do this. In addition, the users may not be able to remove the detected computer virus completely.

For these reasons, in the case where virus check on PCs is users' task, there may be a risk of spreading computer virus infection and damage due to the infection.

On the other hand, many companies focus on carrying out backups of data stored in PCs to avoid an interruption in business. However, it may also be users' task to make the backups, and users may take their own ways to copy data to a file server or external storage medium (such as an optical disc or portable HDD). Therefore, there may be a possibility of not backing up all of important data stored in PCs, which leads to a risk of an interruption in business if a PC fails.

As an example technique relating to the above, the following virus check is performed in a system including a diskless computer and a storage device storing data for booting up the computer. In this system, a virus detection process is performed on a sub-volume of the storage device which stores a copy of data of a main volume of the storage device, and if a computer virus is detected, a virus removal process is performed on the main volume (see, for example, Japanese Laid-open Patent Publication No. 2007-94803).

As another example, there is a network attached storage (NAS) apparatus that, when detecting that a file sent from a client computer is virus-infected, deactivates a file management module using a directory group that is expected to store the file (see, for example, Japanese Laid-open Patent Publication No. 2008-090702).

As described above, in the case where the virus check and backup are users' tasks, not all users may perform the virus check or backup. In addition, the virus check which imposes a heavy load on a computer may lead to inefficient use of the computer.

### SUMMARY

According to an aspect, an information processing apparatus includes: a management apparatus that has a backup unit to read all data from a protected storage device connected to a protected information processing apparatus, and store the read all data as one image file in a backup storage device, a virus detection request unit to make a request for performing a virus detection process on the image file stored in the backup storage device, and a restore unit to read and write the image file from the backup storage device back to the protected storage device upon reception of a completion notification of a virus removal process that is performed on the image file when a computer virus is detected in the image file by the virus detection process performed in response to the request; and a virus detection apparatus that has a virus detection unit to perform the virus detection process on the image file stored in the backup storage device in response to the request from the virus detection request unit, and a virus removal unit to perform the virus removal process on the image file when the computer virus is detected in the image file, and output the completion notification to the restore unit after completing the virus removal process.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration of an information processing system according to a first embodiment;

FIG. 2 illustrates an example configuration of an information processing system according to a second embodiment;

FIG. 3 illustrates an example hardware configuration of a backup server;

FIG. 4 illustrates an example hardware configuration of a storage device;

FIG. 5 is a functional block diagram of the backup server;

FIG. 6 illustrates example data stored in a management table;

FIG. 7 is a functional block diagram of a virus check server;

FIG. 8 is a functional block diagram of a client PC for a backup process and restore process;

FIG. 9 is a sequence diagram of how the information processing system operates in the case where no computer virus is detected in backup data;

FIG. 10 is a sequence diagram of how the information processing system operates in the case where a computer virus is detected in backup data;

FIG. 11 is a view explaining how the backup process and virus check process are performed on a plurality of client PCs;

FIG. 12 is a sequence diagram of how the backup server and client PC operate during a backup process;

FIG. 13 is a sequence diagram of how the backup server and client PC operate during a restore process;

FIG. 14 illustrates an example configuration of an information processing system according to a third embodiment; and

FIG. 15 is a functional block diagram of a backup server according to a fourth embodiment.

### DESCRIPTION OF EMBODIMENTS

Several embodiments will now be described with reference to the accompanying drawings, wherein like reference numerals refer to like elements throughout.

(First Embodiment)

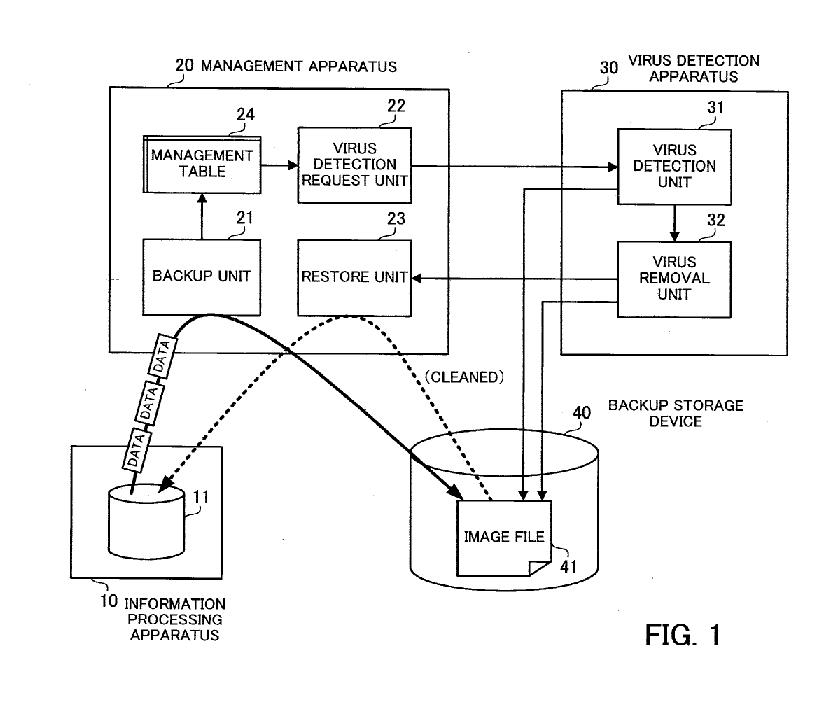

FIG. 1 illustrates a configuration of an information processing system according to a first embodiment.

The illustrated information processing system is a system that manages processes for backup and virus detection to be performed on data stored in a storage device 11 connected to an information processing apparatus 10. This information processing system includes a management apparatus 20 for managing the processes, a virus detection apparatus 30 for performing a virus detection process and a virus removal process, and a backup storage device 40 for storing backup data.

The storage device 11 is protected by the processes and is, for example, a non-volatile storage device, such as an HDD, and is locally connected to the information processing apparatus 10. For example, the storage region of this storage device 11 is treated as a logical volume to be protected in the information processing apparatus 10. In this connection, this storage device 11 may be disposed internal or external to the information processing apparatus 10.

The management apparatus 20 includes a backup unit 21, a virus detection request unit 22, and a restore unit 23. These functions are realized by a CPU of the management apparatus 20 executing predetermined programs.

The backup unit 21 backs up data stored in the protected storage device 11. More specifically, the backup unit 21 reads all data from the storage device 11, and stores the data as one image file 41 in the backup storage device 40.

The virus detection request unit 22 requests the virus detection apparatus 30 to perform a virus detection process on the image file 41 stored in the backup storage device 40 at predetermined timing.

When a computer virus is detected in the image file 41 and then removed therefrom, the restore unit 23 receives a completion notification from the virus detection apparatus 30. Then, the restore unit 23 reads and writes the cleaned image file 41 from the backup storage device 40 back to the storage device 11 of the information processing apparatus 10.

The virus detection apparatus 30 includes a virus detection unit 31 and a virus removal unit 32. For example, these functions are realized by a CPU of the virus detection apparatus 30 executing predetermined programs.

The virus detection unit 31 performs a virus detection process on the image file 41 in response to a request from the virus detection request unit 22. The virus removal unit 32 performs a virus removal process on the image file 41 when a computer virus is detected in the image file 41.

The following describes how to perform the backup process and the virus detection and removal process in this information processing system.

As described above, the backup unit 21 reads all data from the storage device 11, and stores the data as one image file 41 in the backup storage device 40. For example, the backup unit 21 periodically performs this backup.

Data to be read from the storage device 11 by the backup unit 21 includes the data of application software programs and various data to be used in executing the programs. In addition, it is desirable that the data to be read also includes the data of Operating System (OS) and device drivers, which are executed while the information processing apparatus 10 runs.

For example, the backup unit 21 is designed to convert a plurality of data read from the storage device into one image file 41. Alternatively, the backup storage device 40 or information processing apparatus 10 may be designed to perform this conversion.

The virus detection request unit 22 makes a request for performing a virus detection process when a new image file 41 corresponding to the information processing apparatus 10 is stored in the backup storage device 40 or the image file 41 is updated. To manage the backup process performed by the backup unit 21, a management table 24 is prepared. The virus detection request unit 22 reads the management table 24 to determine when to perform the virus detection process. In this connection, the management table 24 is stored in a non-volatile storage medium disposed internal or external to the management apparatus 20, for example.

The virus detection unit 31 performs a virus detection process on a specified image file 41 in response to a request from the virus detection request unit 22. If no computer virus is detected in the image file 41, the virus detection unit 31 notifies the management apparatus 20 of this matter. At this time, the image file 41 is kept as it is in the backup storage device 40 as the backup data corresponding to the storage device 11 of the information processing apparatus 10.

If a computer virus is detected in the image file 41, on the contrary, the virus detection unit 31 notifies the virus removal unit 32 of this matter. The virus removal unit 32 then performs a virus removal process on the image file 41. When this virus removal process is completed, the virus removal unit 32 outputs a completion notification to the restore unit 23. The restore unit 23 reads and writes the cleaned image file 41 from the backup storage device 40 back to the storage device 11 of the information processing apparatus 10. Thereby, the information processing apparatus 10 is able to operate with the data stored in the storage device 11.

In the above information processing system, the management apparatus 20 backs up data of the storage device 11 connected to the information processing apparatus 10. Therefore, this backup process is automatically and reliably performed without requiring any operations or settings by the user of the information processing apparatus 10.

In addition, the virus detection process performed on the image file 41, which is backup data, is also managed by the management apparatus 20. If a computer virus is detected in the image file 41, a virus removal process is automatically performed, and then the cleaned image file 41 is written back to the storage device 11. This makes it possible to automatically and reliably perform the virus detection and removal process without requiring any operations or settings by the user of the information processing apparatus 10.

Further, in the information processing system, an apparatus (i.e., virus detection apparatus 30) different from the information processing apparatus 10 performs the virus detection process on the backup image file 41 stored in the backup storage device 40. Therefore, the processing load of this virus detection is not imposed on the information processing apparatus 10, which provides efficient use of the information processing apparatus 10 for the user. For example, the user is able to use the information processing apparatus 10 as usual even while the virus detection process is in progress.

Still further, not only the virus detection process but also the virus removal process is performed on the image file 41, thereby always keeping virus-free backup data.

Still further, storing a backup of all data of the storage device 11 as one image file 41 leads to efficient use of the storage region of the backup storage device 40. Especially, the image file 41 contains only effective data of the storage device 11, meaning a minimal amount of data, which leads to more efficient use of the storage region of the backup storage device 40.

Still further, in the case where a plurality of information processing apparatuses 10 is under protection, an image file 41 corresponding to each information processing apparatus 10 is stored in the backup storage device 40. The virus detection unit 31 is capable of identifying the image file 41 corresponding to an information processing apparatus 10 as data to be subjected to the virus detection process. Therefore, there is no need to create a logical volume for each information processing apparatus 10 in the backup storage device 40, thus streamlining a process from the storage of data to the backup storage device 40 to the start of the virus detection process.

It is desirable that, when a computer virus is detected in an image file 41, the information processing apparatus 10 corresponding to the image file 41 is isolated from the other information processing apparatuses 10 connected thereto over a network. To do so, the virus detection apparatus 30 or management apparatus 20 is designed to make a request for isolating the information processing apparatus from the other information processing apparatuses when a computer virus is detected in the image file 41. In this case, the information processing apparatus 10 may be re-connected to the network in response to a request from the management apparatus 20 after the cleaned image file 41 is written back to the information processing apparatus 10 by the restore unit 23. This makes it possible to guard against spreading of computer virus infection and damage due to the infection regardless of how users operate the information processing apparatuses 10 or the users' skill levels.

(Second Embodiment)

The following more concretely describes an information processing system provided with a centralized management function for the above-described backup process and virus detection and removal process. In addition to this function, this system is provided with a function for automatically preventing the spreading of damage due to computer virus.

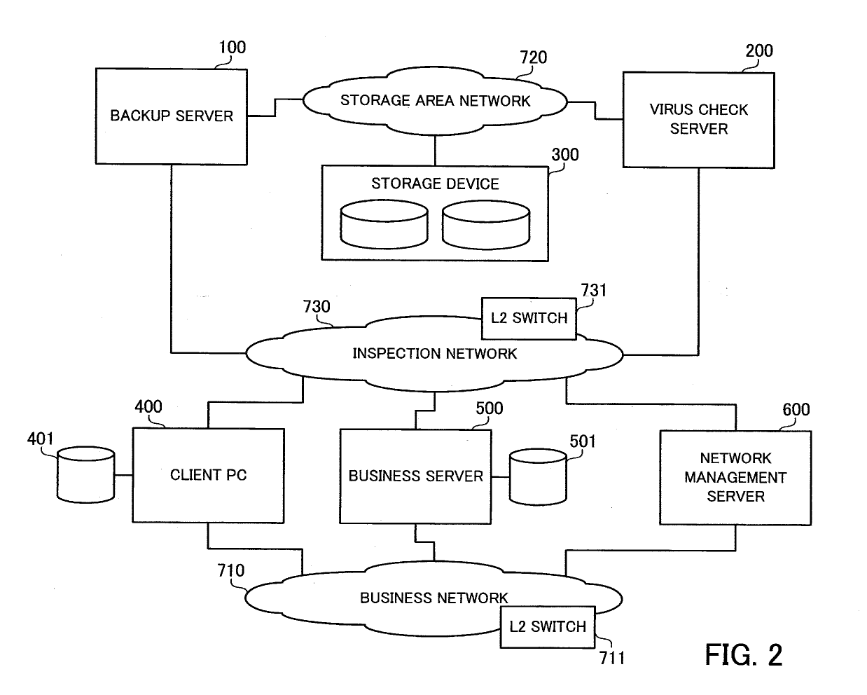

FIG. 2 illustrates an example configuration of an information processing system according to a second embodiment.

The illustrated information processing system includes a backup server 100, a virus check server 200, a storage device 300, a client PC 400, a business server 500, and a network management server 600.

This information processing system is implemented, for example, in a company. The client PC 400 and business server 500 are connected to each other via a business network 710. The client PC 400 is used by the employees of the company. The employees use the client PC 400 to access the business server 500 according to necessity to do their tasks.

A storage device 401 such as an HDD is locally connected to the client PC 400. This storage device 401 may be disposed internal or external via a Universal Serial Bus (USE) interface to the client PC 400. In addition, in this embodiment, OS, device drivers, and the like to be executed while the client PC 400 runs are stored in the storage device 401.

A storage device 501 is locally connected to the business server 500. Similarly to the client PC 400 and storage device 401, this storage device 501 may be disposed internal or external via a USE interface to the business server 500.

In this connection, a plurality of client PCs 400 may be provided. Similarly, a plurality of business servers 500 may be provided.

On the other hand, the backup server 100, the virus check server 200, and the storage device 300 are mutually connected to each other via a storage area network 720. The backup server 100 and virus check server 200 are also connected to an inspection network 730. The client PC 400 and business server 500 are connected to this inspection network 730 as well.

The backup server 100 manages the execution state of a backup process performed on the client PC 400, and performs a backup process when required. In this backup process, the backup server 100 reads all data from the storage device 401 connected to the client PC 400, and stores the data as one image file in the storage device 300. In addition, the backup server 100 also manages the execution state of a virus check process performed on the client PC 400, and causes the virus check server 200 to perform the virus check process on backup data when required. In this connection, the execution states of the backup process and virus check process may be managed with respect to not only the client PC 400 but also the business server 500 and others.

The virus check server 200 performs a virus check process and a virus removal process in response to a request from the backup server 100. In this connection, the virus check process and virus removal process are performed not on data stored in the storage device 401 connected to the client PC 400 but on an image file stored as backup data of the data in the storage device 300.

After a computer virus is detected in the image file in the storage device 300 and then the virus removal process is performed on the image file, the virus check server 200 informs the backup server 100 of its completion. The backup server 100 then reads and writes the cleaned image file from the storage device 300 back to the storage device 401 of the corresponding client PC 400, thereby completing the virus check process and the virus removal process for the storage device 401 of the client PC 400.

The storage device 300 may be a NAS or Storage Area Network (SAN) storage so as to provide a common storage region for apparatuses to share. This storage region is realized by an HDD, for example. In this embodiment, the image file which is backup data of the client PC 400 is stored in the storage device 300.

In addition, the network management server 600 is connected to the business network 710 and inspection network 730. The network management server 600 is capable of physically or logically isolating a specified apparatus from the other apparatuses on the business network 710. The network management server 600 is also capable of physically or logically isolating a specified apparatus from the other apparatuses on the inspection network 730.

In this embodiment, the business network 710 and inspection network 730 are both LANs, for example. The apparatuses in the business network 710 are connected via an L2 (Layer 2) switch 711. The apparatuses in the inspection network 730 are connected via an L2 switch 731. The network management server 600 is capable of controlling the connection status of each apparatus to the L2 switch 711, 731 in response to a request from the backup server 100, virus check server 200, or the like.

In this connection, in the above system, the storage area network 720 may not be provided, and the storage device 300 may be connected to the inspection network 730 instead. In this case, the backup server 100 and virus check server 200 access the storage device 300 via the inspection network 730.

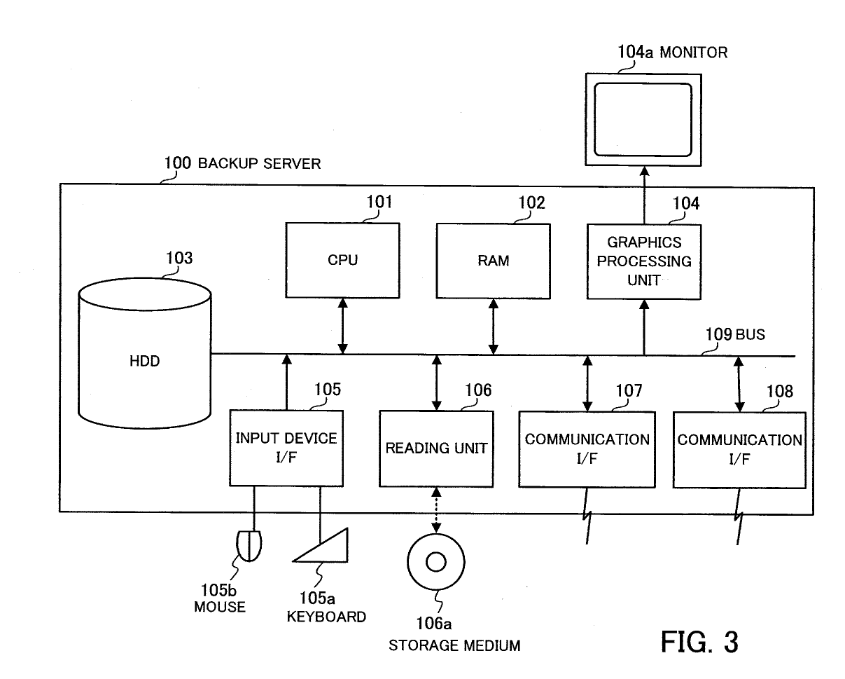

FIG. 3 illustrates an example hardware configuration of a backup server.

The backup server 100 is realized by a computer illustrated in FIG. 3, for example. This computer includes a CPU 101, Random Access Memory (RAM) 102, HDD 103, graphics processing unit 104, input device interface (I/F) 105, a reading unit 106, and communication interfaces 107 and 108. These units are connected to each other via a bus 109.

The CPU 101 entirely controls this computer by executing various programs stored in the HDD 103. The RAM 102 temporarily stores at least part of programs to be executed by the CPU 101, and also stores various data to be used in executing the programs. The HDD 103 stores the programs and various data to be used by the CPU 101.

A monitor 104a is connected to the graphics processing unit 104, for example. The graphics processing unit 104 displays an image on the screen of the monitor 104a under the control of the CPU 101. A keyboard 105a and mouse 105b are connected to the input device interface 105, for example. This input device interface 105 transfers signals from the keyboard 105a and mouse 105b to the CPU 101 via the bus 109.

The reading unit 106 reads data from a portable storage medium 106a, and supplies the data to the CPU 101 via the bus 109. As the storage medium 106a, an optical disc may be used. The communication interfaces 107 and 108 connect to and communicate with external apparatuses via the storage area network 720 and inspection network 730, respectively.

Basically, the virus check server 200, client PC 400, business server 500, and network management server 600 may have the same hardware configuration as illustrated for the backup server 100 in FIG. 3. In this case, the storage devices 401 and 501 connected to the client PC 400 and business server 500, respectively, correspond to the HDD 103 illustrated in FIG. 3. As described later, a communication interface provided in the client PC 400 for connection to the inspection network 730 supports Wake on Lan (WoL) and Preboot eXecution Environment (PXE). In addition, in the case of having the business server 500 protected by the backup server 100, the business server 500 is provided with a communication interface that supports WoL and PXE.

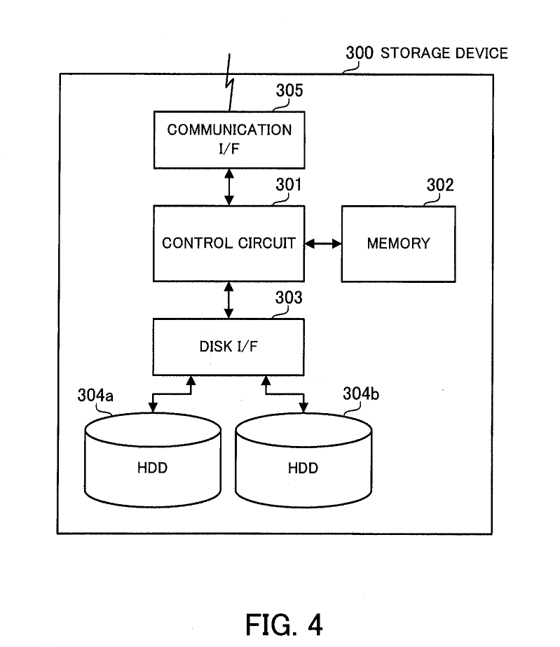

FIG. 4 illustrates an example hardware configuration of a storage device.

The illustrated storage device 300 includes a control circuit 301, memory 302, disk interface (I/F) 303, HDDs 304a and 304b, and communication interface (I/F) 305. This storage device 300 provides the two HDDs 304a and 304b, for example, as storage regions for a plurality of apparatuses to share.

The control circuit 301 entirely controls the storage device 300. For example, the control circuit 301 controls data read and write on the HDDs 304a and 304b in response to requests received from an external apparatus via the communication interface 305.

The memory 302 stores various data to be used by the control circuit 301. The disk interface 303 performs data read and write on the HDDs 304a and 304b in response to requests from the control circuit 301. The communication interface 305 connects to and communicates with an external apparatus over the storage area network 720.

The following describes the functions of each apparatus in the information processing system.

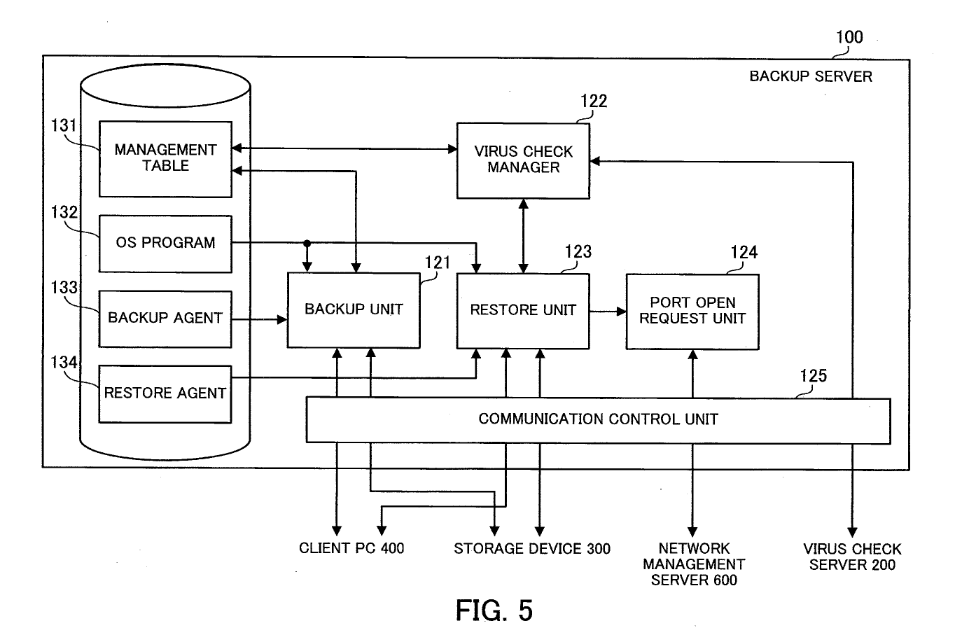

FIG. 5 is a functional block diagram of a backup server.

The backup server 100 includes a backup unit 121, a virus check manager 122, restore unit 123, a port open request unit 124, and communication control unit 125.

The backup unit 121 reads a management table 131 to manage the execution schedule of a backup process to be performed on the client PC 400. For example, the management table 131 is stored in an HDD connected to the backup server 100, for example. Then, the backup unit 121 performs the backup process on the client PC 400 at predetermined timing.

In this backup process, the backup unit 121 reads an OS program 132 and backup agent 133 from a storage device, such as an HDD, as programs for causing the client PC 400 to execute data read. Then, the backup unit 121 utilizes the PXE boot function of the client PC 400 to send these programs to the client PC 400 via the communication control unit 125, thereby causing the CPU of the client PC 400 to execute the programs. As a result, all data is sequentially read from the storage device 401 of the client PC 400. The backup unit 121 converts the read data into one image file which is then stored in the storage device 300.

The virus check manager 122 reads the management table 131 to manage the virus check process performed on an image file that is backup data. If determining that the image data needs to be checked for virus, the virus check manager 122 notifies the virus check server 200 of the location of the image file via the communication control unit 125, and requests the virus check server 200 to perform a virus check process. In addition, the virus check manager 122 receives a result of the virus check process or virus removal process from the virus check server 200, and where appropriate, updates the management table 131 or requests the restore unit 123 to perform a restore process.

The restore unit 123 performs a restore process of writing the image file of the storage device 300 back to the storage device 401 of the client PC 400 in response to a request from the virus check manager 122. In this restore process, the restore unit 123 reads the QS program 132 and a restore agent 134 from the storage device, such as an HDD, as programs for causing the client PC 400 to execute data write. Then, the restore unit 123 utilizes the PXE boot function of the client PC 400 to send these programs to the client PC 400 via the communication control unit 125, thereby causing the CPU of the client PC 400 to execute the programs. As a result, the restore unit 123 replaces the data stored in the storage device 401 connected to the client PC 400 with the image file read from the storage device 300.

The port open request unit 124 communicates with the network management server 600 via the communication control unit 125 in response to a request from the restore unit 123 when the restore process is completed. The port open request unit 124 makes a request for opening the port of the L2 switch 711 connected to the client PC 400 in which the restore process is complete, thereby reconnecting the client PC 400 to the business network 710.

The above backup unit 121, virus check manager 122, restore unit 123, and port open request unit 124 are realized by the CPU of the backup server 100 executing predetermined application programs.

The communication control unit 125 performs a process required for communicating with another apparatus via a LAN. The communication control unit 125 also executes an Internet Control Message Protocol (ICMP) communication process or a communication process for a wakeup request using WoL or remote control using PXE booting with the client PC 400 in response to a request from the backup unit 121 or restore unit 123. In this connection, this communication control unit 125 is realized, for example, by the CPU executing part of a communication interface device driver and OS program provided in the backup server 100.

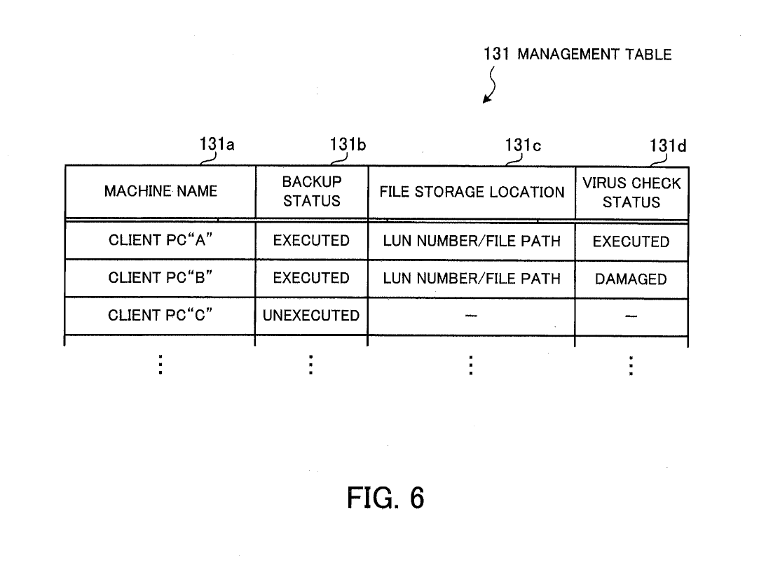

FIG. 6 illustrates example data stored in a management table.

The management table 131 contains a backup status 131b, a file storage location 131c, and virus check status 131d in association with a machine name 131a identifying a protected apparatus.

The backup status 131b indicates whether a backup of a corresponding protected apparatus has been executed or not. This status may include not only a flag indicating whether the backup has been executed or not, but also the execution time of the last backup. Even when a flag is updated to indicate that a backup has been executed, this flag may automatically be changed to one indicating that a backup has not been executed after a predetermined time elapses.

The file storage location 131c indicates where the image file that is backup data of a corresponding protected apparatus is. The storage location may be represented by a Logical Unit Number (LUN) assigned to an HDD of a storage device 300 storing the image file, a file path thereof, and others.

The virus check status 131d indicates whether a virus check on image data is successful. In the case where there is no computer virus detected by the virus check or in the case where computer viruses are detected and then removed with a virus removal process, information indicating an “executed” state is stored. During a virus removal process, information indicating this matter (represented as “damaged” in FIG. 6) is stored.

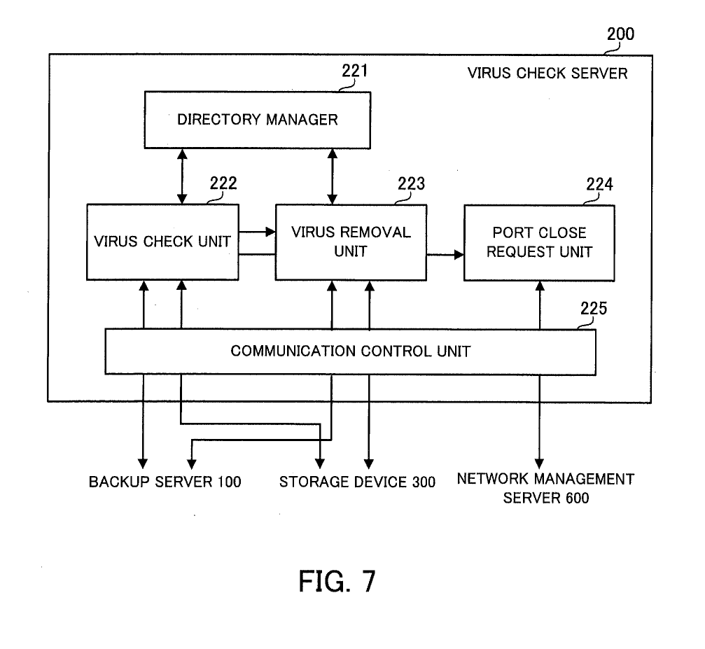

FIG. 7 is a functional block diagram of a virus check server.

The virus check server 200 includes a directory manager 221, virus check unit 222, virus removal unit 223, port close request unit 224, and communication control unit 225.

The directory manager 221 manages file directories in the virus check server 200. For example, the directory manager 221 mounts one or a plurality of image files stored in the storage device 300 on a logical volume that is managed by the virus check server 200, in response to a request from the virus check unit 222. The functions of the directory manager 221 are realized by a file system provided by an OS running on the virus check server 200.

The virus check unit 222 performs a virus check process on an image file that is stored in the storage device 300 and specified by the backup server 100. A well-known method is applicable for this virus check process. For example, an image file is scanned by using a virus definition file (not illustrated) to check whether the image file includes code patterns identical to virus patterns or not.

The virus removal unit 223 performs a virus removal process on an image file when the virus check unit 222 detects a computer virus in the image file. In this process, the detected code patterns, which are identical to virus patterns, are all overwritten with “0”.

When the virus check unit 222 detects a computer virus, the port close request unit 224 requests the network management server 600 via the communication control unit 225 to close the port of the L2 switch 711 connected to the corresponding client PC 400, thereby isolating the client PC 400 from the business network 710.

The functions of the above virus check unit 222, virus removal unit 223, and port close request unit 224 are realized by the CPU of the virus check server 200 executing predetermined application programs.

The communication control unit 225 is provided for communicating with another apparatus via a LAN. This communication control unit 225 is realized by the CPU executing part of communication interface device driver and OS programs provided in the virus check server 200, for example.

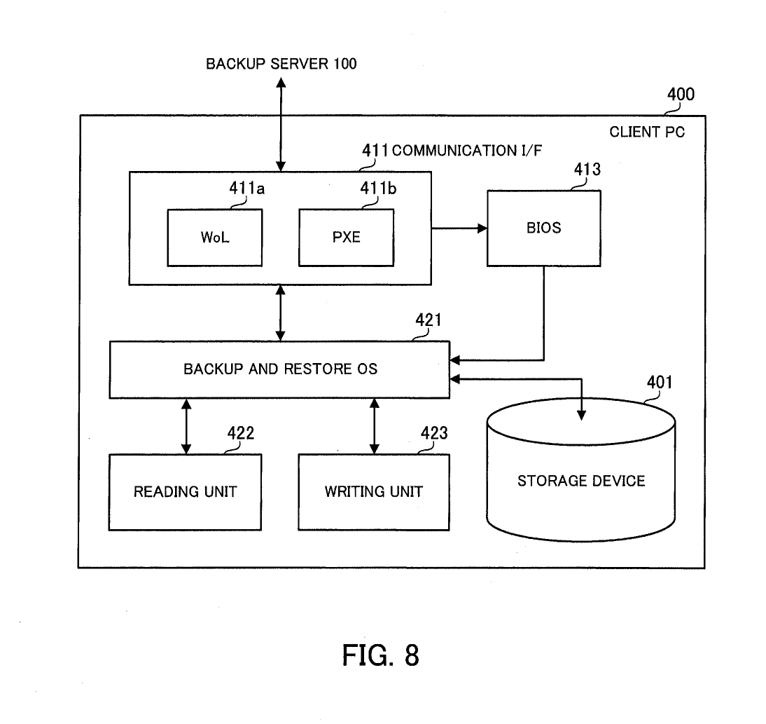

FIG. 8 is a functional block diagram of a client PC for a backup process and restore process.

The client PC 400 includes a communication interface (I/F) 411 for communicating with an external apparatus via a LAN. This communication interface 411 includes a WoL processor 411a and PXE processor 411b.

The WoL processor 411a turns on the client PC 400 when receiving a specified packet (for example, Magic Packet) from the backup server 100 while the client PC 400 is powered off (shut down). At this time, the WoL processor 411a makes a request for executing a BIOS program in accordance with the received packet to activate the functions of a BIOS 413, so as to turn on the client PC 400.

When the client PC 400 is turned on by the WoL processor 411a, the PXE processor 411b communicates with the backup server 100 in accordance with data stored in a ROM (not illustrated) provided in the communication interface 411 before the OS in the storage device 401 starts running. Then, the PXE processor 411b downloads OS programs 132 for the backup and restore processes from the backup server 100, and causes the CPU (not illustrated) of the client PC 400 to execute the OS programs 132, thereby activating the functions of a backup and restore OS 421.

Furthermore, the PXE processor 411b downloads a backup agent 133 or restore agent 134 from the backup server 100, and causes the CPU to run the agent. These agents are run on the backup and restore OS 421. The backup agent 133 realizes the functions of a reading unit 422, and the restore agent 134 realizes the functions of a writing unit 423. The reading unit 422 sequentially reads all data from the storage device 401 in response to a request from the backup server 100, and sends the data to the backup server 100. The writing unit 423 replaces the data of the storage device 401 with a cleaned image file received from the backup server 100.

In this connection, the OS installed in the storage device 401 in advance and the OS downloaded from the backup server 100 are allowed to share a common file system, for example. Thereby, the backup and restore OS 421 is capable of recognizing files stored in the storage device 401 on the basis of an OS file system stored in the storage device 401. In the case where an OS like Windows (TM) is installed in the client PC 400 in advance, Windows PE (TM) may be used as an OS to be downloaded from the backup server 100.

The following describes what are performed in the above information processing system.

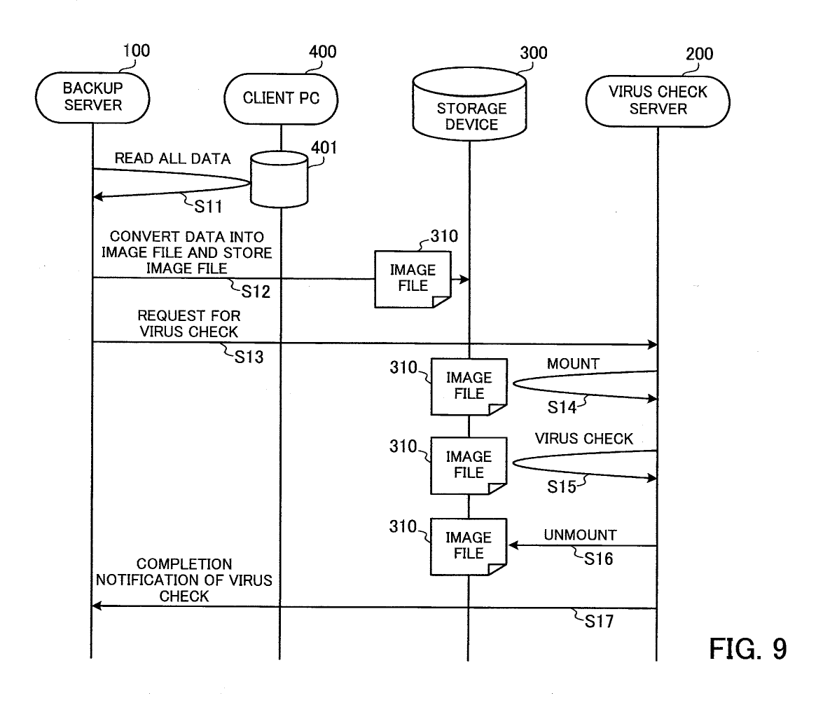

FIG. 9 is a sequence diagram of how the information processing system operates in the case where no computer virus is detected in backup data.

First, a backup process is performed on the client PC 400 under the control of the backup server 100.

The reading unit 422 of the client PC 400 reads all data from the storage device 401 and sends the data to the backup server 100 via the communication interface 411 (step S11). The functions of the reading unit 422 are realized by the backup agent 133 received from the backup server 100. The backup unit 121 of the backup server 100 converts the data received from the client PC 400 into one image file 310, and stores the image file 310 into the storage device 300 (step S12). This backup procedure will be described in detail later.

In the backup server 100, when the image file 310 is stored in the storage device 300, the backup unit 121 registers the storage location of the image file 310 in the file storage location field 131c of the management table 131. At the same time, the backup status 131b is updated to indicate an “executed” state. The virus check manager 122 monitors the backup status 131b of the management table 131, for example, at predetermined intervals. Then, when the backup of the client PC 400 is detected, the virus check manager 122 requests the virus check server 200 to perform virus check on the client PC 400 (step S13). At this time, the virus check manager 122 informs the virus check server 200 of the storage location of the corresponding image file 310 and information identifying the corresponding client PC 400 (for example, network address).

In the virus check server 200, the virus check unit 222, having received the virus check request, requests the directory manager 221 to mount the image file 310 on an own logical volume. Thereby, a storage region (for example, volume) storing the image file 310 is mounted as one logical volume to be managed by the virus check server 200 (step S14).

By the way, many commercially available virus check and removal programs target logical volumes of information processing apparatuses having the programs installed thereon, for virus check and removal. This mounting process enables one of such virus check and removal programs to be used as a processing program provided by the virus check server 200. Therefore, without increasing system cost, the virus check and removal process is performed on the image file 310 without fail.

Then, the virus check unit 222 performs a virus check process on the mounted image file 310 (step S15). If no computer virus is detected by this check, the virus check unit 222 requests the directory manager 221 to unmount the image file 310 from the virus check server 200 (step S16). After the image file 310 is unmounted, the virus check unit 222 notifies the backup server 100 of the completion of the virus check (step S17). The virus check manager 122 of the backup server 100, having received the notification of completion of the virus check, updates the corresponding virus check status 131d of the management table 131 to indicate the “executed” state.

The above procedure makes it possible to store the backup data of the client PC 400 in the storage device 300 and guarantee that the backup data is free from computer viruses.

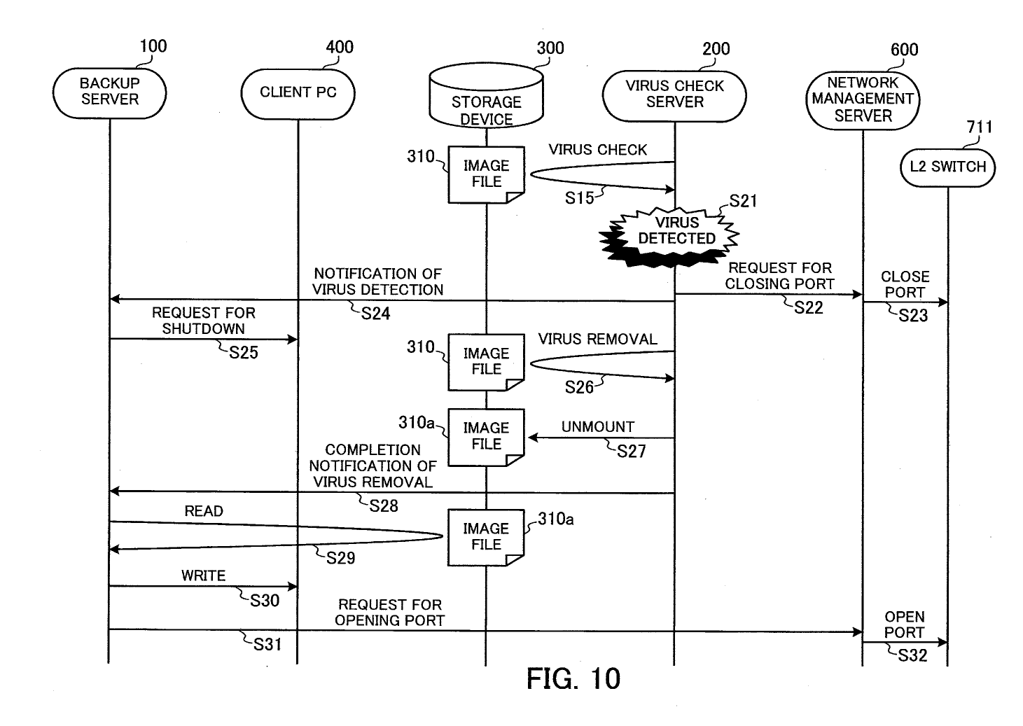

FIG. 10 is a sequence diagram of how the information processing system operates when a computer virus is detected in backup data. FIG. 10 does not illustrate a process from start of backup to virus check because this process is performed in the same way as illustrated in FIG. 9.

Assume now that a computer virus is detected in the image file 310 by the virus check at step S15 (step S21). In this case, the virus check unit 222 of the virus check server 200 requests the port close request unit 224 to disconnect the corresponding client PC 400 from the business network 710 by giving information identifying the client PC 400. The port close request unit 224 in turn requests the network management server 600 to close the port of the L2 switch 711 connected to the client PC 400 out of the connection ports thereof (step S22).

The network management server 600 closes the specified port of the L2 switch 711 in response to the request from the virus check server 200 (step S23). Thereby, the client PC 400 is disconnected from the business network 710, so as to prevent the business server 500 and other apparatuses including the other client PCs 400 existing on the business network 710 from being infected.

Then, the virus check unit 222 notifies the backup server 100 that the computer virus has been detected (step S24). Upon receipt of this notification, the virus check manager 122 of the backup server 100 updates the corresponding virus check status 131d of the management table 131 to indicate that the computer virus has been detected (“damaged” in FIG. 6). Further, the virus check manager 122 requests the communication control unit 125 to shut down the corresponding client PC 400. The communication control unit 125 sends a shutdown request packet to the client PC 400 (step S25), thereby forcibly shutting down the client PC 400.

In this connection, when a computer virus is detected, the client PC 400 may forcibly be shut down under the control of the virus check server 200. To do so, in the virus check server 200, the communication control unit 225 which has received a notification of virus detection from the virus check unit 222 may be designed to send a shutdown request packet to the client PC 400.

Then, the virus check unit 222 requests the virus removal unit 223 to perform a virus removal process by giving information on where the computer virus has been detected. The virus removal unit 223 performs a virus removal process on the image file 310 on the basis of the received information (step S26).

When completing the virus removal process, the virus removal unit 223 requests the directory manager 221 to unmount the cleaned image file 310 (here, represented as image file 310a). Thereby, the storage region storing the image file 310a in the storage device 300 becomes a logical volume independent from the virus check server 200 (step S27). Then, the virus removal unit 223 notifies the backup server 100 that the virus removal process is complete (step S28).

Upon receipt of the notification of completion of the virus removal process, the virus check manager 122 of the backup server 100 updates the corresponding virus check status 131d of the management table 131 to indicate the “executed” state. Then, the virus check manager 122 notifies the restore unit 123 of the location of the image file 310a and information identifying the corresponding client PC 400, so as to start the restore process.

The restore unit 123 reads the image file 310a from the storage device 300 (step S29), sends the file to the corresponding client PC 400. In the client PC 400, the writing unit 423 writes the image file 310a received from the backup server 100 into the storage device 401 (step S30). The functions of this writing unit 423 are realized by executing the restore agent 134 received from the backup server 100. The processes of the backup server 100 and client PC 400 for the restore process will be described in detail later.

The restore unit 123 of the backup server 100 requests the port open request unit 124 to reconnect the corresponding client PC 400 to the network 710 by giving information identifying the client PC 400. The port open request unit 124 in turn requests the network management server 600 to open the port of the L2 switch 711 connected to the client PC 400 out of the connection ports thereof (step S31). The network management server 600 opens the specified port of the L2 switch 711 in response to the request from the backup server 100 (step S32), thereby reconnecting the client PC 400 to the business network 710.

According to the procedures illustrated in FIGS. 9 and 10, the backup process and the virus check and removal process are automatically performed on the client PC 400 under the control of the backup server 100. These processes are performed without fail without requiring special operations or settings by the user of the client PC 400. This prevents important data for a user from being lost due to a trouble in the client PC 400, and at the same time prevents damages due to computer viruses, such as information leakage from the client PC 400.

Further, the backup and virus check processes are performed on an image file stored in the storage device 300, so that the user is able to use the client PC 400 as usual during these processes. Further, not only the virus check process but also the virus removal process is performed on the image file, so that it is guaranteed that the backup data is always free from computer viruses.

Still further, all data of the storage device 401 of the client PC 400 is backed up as one image file, so as to enhance the usability of the storage region of the storage device 300, and at the same time, to enhance the efficiency of a process of storing backup data to the storage device 300 and a process of writing the cleaned backup data back to the storage device 401.

Still further, when a computer virus is detected in backup data, the corresponding client PC 400 is automatically disconnected from the business network 710. At this time, the client PC 400 is automatically shut down. Therefore, regardless of how users operate the client PC 400 or the users' skill levels, spreading of computer virus infection and damage due to the infection may be prevented. Then, after the virus removal process is completed and the backup data is written back, the client PC 400 is automatically reconnected to the business network 710, so as to improve the user friendliness of the client PC 400.

In this connection, in FIG. 10, it is the virus check server 200 that makes a request for disconnecting the client PC 400 from the business network 710 when a computer virus is detected (step S22). However, this request may be made by the backup server 100 which receives a notification of virus detection (step S24). In this case, the virus check server 200 may not need to be connected to the network management server 600. The connection and disconnection of the client PC 400 to and from the business network 710 are collectively controlled by the backup server 100.

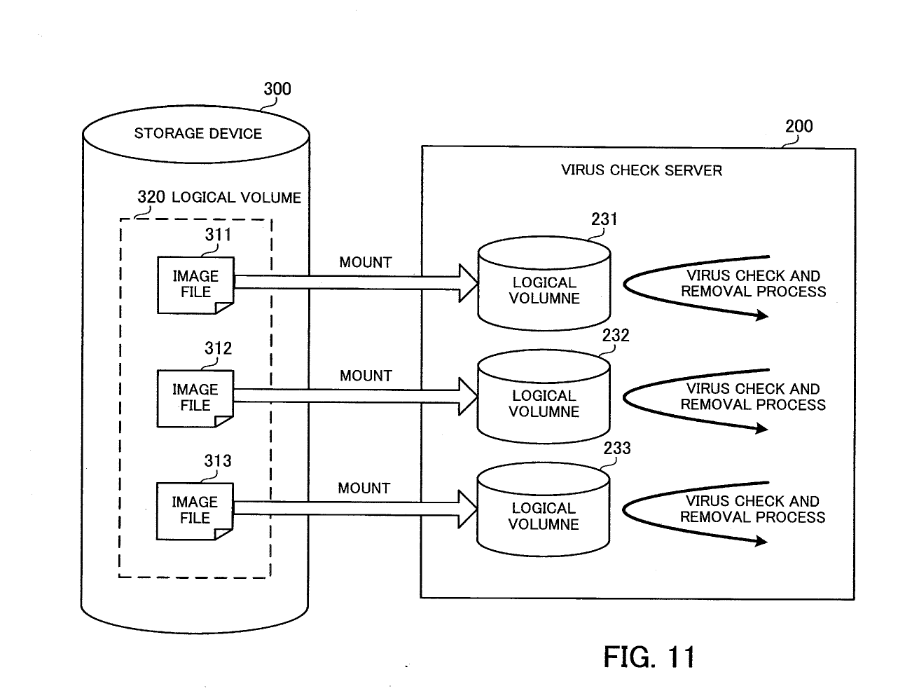

The following additionally describes advantages in treating all data of the storage device 410 of the client PC 400 as one image file. FIG. 11 is a view explaining how a backup process and virus check process are performed on a plurality of client PCs.

In the case where a plurality of client PCs 400 is protected by the backup server 100, a backup process is performed on each client PC 400. As a result, as illustrated in FIG. 11, image files corresponding to the respective client PCs 400 are stored in the storage device 300. FIG. 11 illustrates an example in which three client PCs 400 are under protection, and the image files 311 to 313 corresponding the respective client PCs 400 are stored in the storage device 300.

In this case, the virus check unit 222 of the virus check server 200 causes the directory manager 221 to mount the image files 311 to 313 on separate logical volumes 231 to 233. Then, the virus check unit 222 performs the virus check process on each image file 311 to 313, i.e., each logical volume 231 to 233.

Suppose now that the data of the client PC 400 is stored in the storage device 300 as it is, not being converted into an image file. A logical volume may be created for each client PC 400 in the storage device 300 so that the virus check server 200 identifies data corresponding to one client PC 400 on the basis of the logical volumes to mount the data on a logical volume for virus check. Therefore, this case need to create as many logical volumes as the number of client PCs 400 to be subjected to the virus check in the storage device 300.

On the other hand, in this embodiment where an image file is generated from the data of each client PC 400, the generated image files may be stored in the same logical volume 320 created in the storage device 300. Therefore, even if more client PCs 400 need to be subjected to the virus check process, new logical volumes do not need to be created in the storage device 300. The virus check server 200 takes one image file from the logical volume 320 and mounts the image file on one logical volume, so as to recognize each client PC 400 for the virus check. This streamlines the process from data storage to the storage device 300 to start of a virus check process.

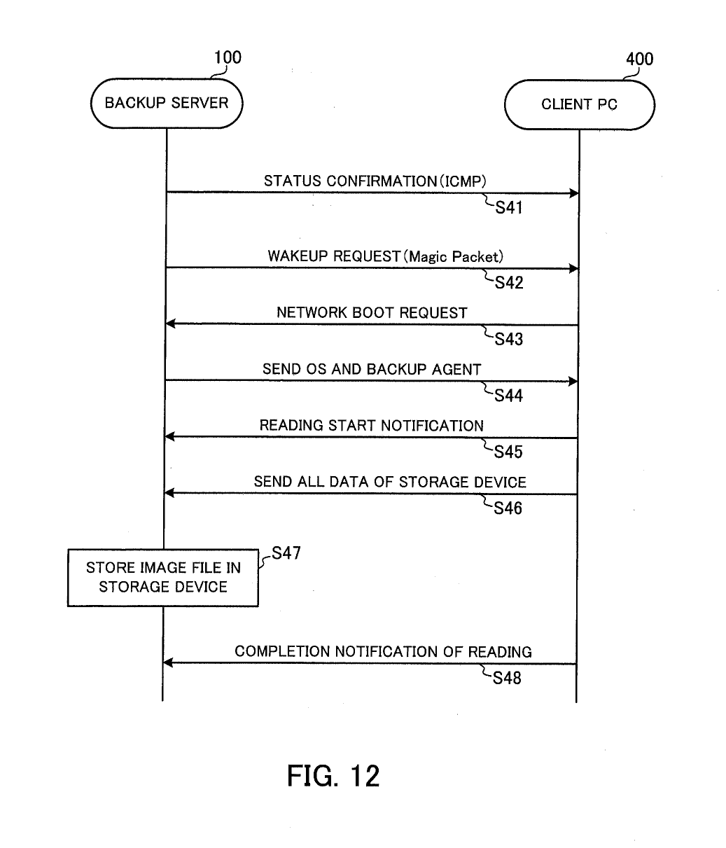

The following describes, in detail, how the backup server 100 and the client PC 400 operate during the backup process and the restore process. FIG. 12 is a sequence diagram of how a backup server and client PC operate during a backup process.

The backup unit 121 of the backup server 100 requests the communication control unit 125 to perform a process of confirming whether the client PC 400 is active or shut down. This request is made by supplying a ping command to the communication control unit 125. In this case, the communication control unit 125 sends an ICMP packet to the client PC 400 to be subjected to the backup process, and waits for its response (step S41). The communication control unit 125 confirms that the client PC 400 is active when receiving a response, and that the client PC 400 is shut down when receiving no response.

Assume now that the client PC 400 is determined to be shut down. In this case, the backup unit 121 requests the communication control unit 125 to turn on the client PC 400. The communication control unit 125 sends a wakeup request packet (Magic Packet) to the client PC 400 (step S42).

In the client PC 400, the WoL processor 411a of the communication interface 411 makes an activation request to the BIOS 413 upon receipt of the wakeup request packet. Thereby, the client PC 400 is turned on. In addition, before the OS of the storage device 401 starts running, the PXE processor 411b connects to the backup server 100 to make a network boot request (step S43). The backup unit 121 of the backup server 100 reads the OS program 132 and backup agent 133 from the storage device, and requests the communication control unit 125 to send them to the client PC 400. Thereby, the OS program 132 and backup agent 133 are sent to the client PC 400 (step S44).

In the client PC 400, the OS program 132 and backup agent 133 received from the backup server 100 are downloaded, for example, into a RAM, under the control of the BIOS 413, and then, the downloaded OS program 132 is executed by the CPU, so that the backup and restore OS 421 is activated. Further, the backup agent 133 is executed, so that the reading unit 422 is activated. The activated reading unit 422 notifies the backup server 100 of the reading start via the communication interface 411 (step S45). Then, the reading unit 422 reads all data from the data storage region of the storage device 401, that is, a storage region storing effective data, and then sequentially sends the read data to the backup server 100 via the communication interface 411 (step S46).

The backup unit 121 of the backup server 100 converts the data received from the client PC 400 into one image file 310, and stores the image file 310 into the storage device 300 (step S47). When all of the data of the storage device 401 is sent, the reading unit 422 of the client PC 400 notifies the backup server 100 of the completion of the reading via the communication interface 411 (step S48), thereby completing the backup process. Then, the client PC 400 is shut down or re-booted, and the functions of the reading unit 422 and backup and restore OS 421 are deleted.

According to the above procedure, even while the client PC 400 is shut down, the backup process is performed under the remote control of the backup server 100. This means that the backup process may be performed while the client PC 400 is not used, for example, during night time, which does not deteriorate the work efficiency of the user using the client PC 400.

Further, the reading unit 422 in the client PC 400 performs a simple process of reading and sending all effective data from the storage device 401, which contributes to reducing processing time. In addition, the backup agent 133 and the OS program 132 for operating the backup agent are small in size, which also contribute to reducing time for downloading and installing them.

The above description exemplifies the case where the backup process starts while the client PC 400 is shut down. However, when the client PC 400 is active, the backup server 100 may send the backup agent 133 to the client PC 400 to perform the backup process, for example. Alternatively, the backup server 100 shuts down the client PC 400 once, and then step S42 and successive steps may be executed so as to perform the backup process.

In addition, in the above example, all data from the storage device 401 is converted into an image file by the backup unit 121 of the backup server 100. Alternatively, this conversion may be performed by the reading unit 422 of the client PC 400. Yet alternatively, the control circuit 301 of the storage device 300 may be designed to perform this conversion so as to store the data in the storage device 300.

Further, the backup server 100 may be designed to control the connection and disconnection of the client PC 400 to and from the inspection network 730 as follows, which is not illustrated. The backup server 100 normally keeps the protected client PC 400 disconnected from the inspection network 730. Then, just before starting the backup process, the backup server 100 requests the network management server 600 to connect the protected client PC 400 to the inspection network 730. Then, when the virus check is completed (corresponding to step S17 of FIG. 9), or when the restore is completed (corresponding to step S31 of FIG. 10), the backup server 100 requests the network management server 600 to disconnect the corresponding client PC 400 from the inspection network 730. In this connection, the network management server 600 controls a specified port of the L2 switch 731 in response to a request from the backup server 100 so as to connect or disconnect the client PC 400 to or from the inspection network 730. Even if a client PC 400 is infected by a computer virus, this approach prevents computer virus from spreading to other client PCs 400 over the inspection network 730.

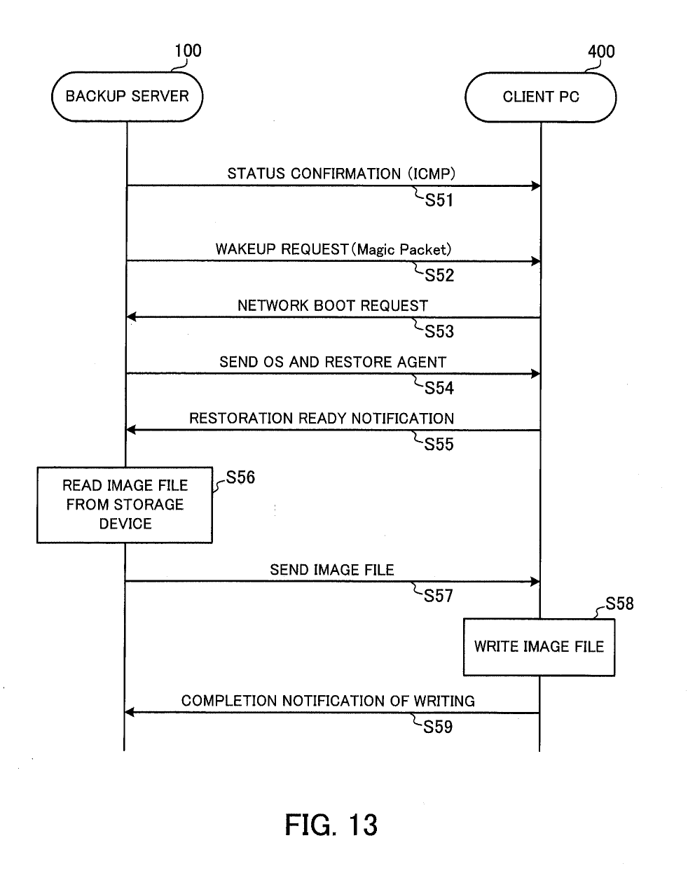

FIG. 13 is a sequence diagram of how a backup server and client PC operate during a restore process.

When requested to perform a restore process from the virus check manager 122, the restore unit 123 of the backup server 100 first requests the communication control unit 125 to check whether the client PC 400 is active or shut down. This process corresponds to step S41 of FIG. 12, so that an ICMP packet is sent to the client PC 400 (step S51).

As a computer virus is detected in an image file, the client PC 400 is forcibly shut down, as in step S25 of FIG. 10. Therefore, the client PC 400 does not make a response to the ICMP packet. When the restore unit 123 confirms that the client PC 400 is shut down, the restore unit 123 requests the communication control unit 125 to turn on the client PC 400. The communication control unit 125 sends a wakeup request packet (Magic Packet) to the client PC 400 (step S52).

In the client PC 400, when the WoL processor 411a of the communication interface 411 receives the wakeup request packet, the BIOS 413 is activated. Thereby the client PC 400 is turned on. In addition, the PXE processor 411b connects to the backup server 100 to make a network boot request before the OS of the storage device 401 starts running (step S53). The restore unit 123 of the backup server 100 reads the OS program 132 and restore agent 134 from the storage device, and requests the communication control unit 125 to send them to the client PC 400. Thereby, the OS program 132 and restore agent 134 are sent to the client PC 400 (step S54).

In the client PC 400, the OS program 132 and restore agent 134 from the backup server 100 are downloaded, for example, into a RAM under the control of the BIOS 413. Then, the downloaded OS program 132 is executed by the CPU, so that the backup and restore OS 421 is activated. Further, the restore agent 134 is executed, so that the writing unit 423 is activated. The writing unit 423 notifies the backup server 100 that the restore process is ready to be performed via the communication interface 411 (step S55).

The restore unit 123 of the backup server 100 reads a specified image file from the storage device 300 (step S56), and sends the file to the client PC 400 (step S57). The writing unit 423 of the client PC 400 writes the image file received from the backup server 100 into the storage device 401 (step S58). In this writing, all data stored in the storage device 401 is replaced with the image file.

When completing the writing of the image file, the writing unit 423 notifies the backup server 100 of the writing completion via the communication interface 411 (step S59), thereby completing the restore process. Then, the client PC 400 is shut down, and the functions of the writing unit 423 and the backup and restore OS 421 are deleted.

According to the above procedure, even while the client PC 400 is not active, the restore process is performed under the remote control of the backup server 100. Therefore, the client PC 400 is caused to be shut down after detection of a computer virus and immediately before start of the restore process, thus making it possible to prevent spreading of the computer virus.

In addition, one image file is written back to the storage device 401 by the restore process. This eliminates the need of reading and updating information of the file system every time each of a large number of data files is written, thereby simplifying the writing process and also reducing processing time for the writing.

(Third Embodiment)

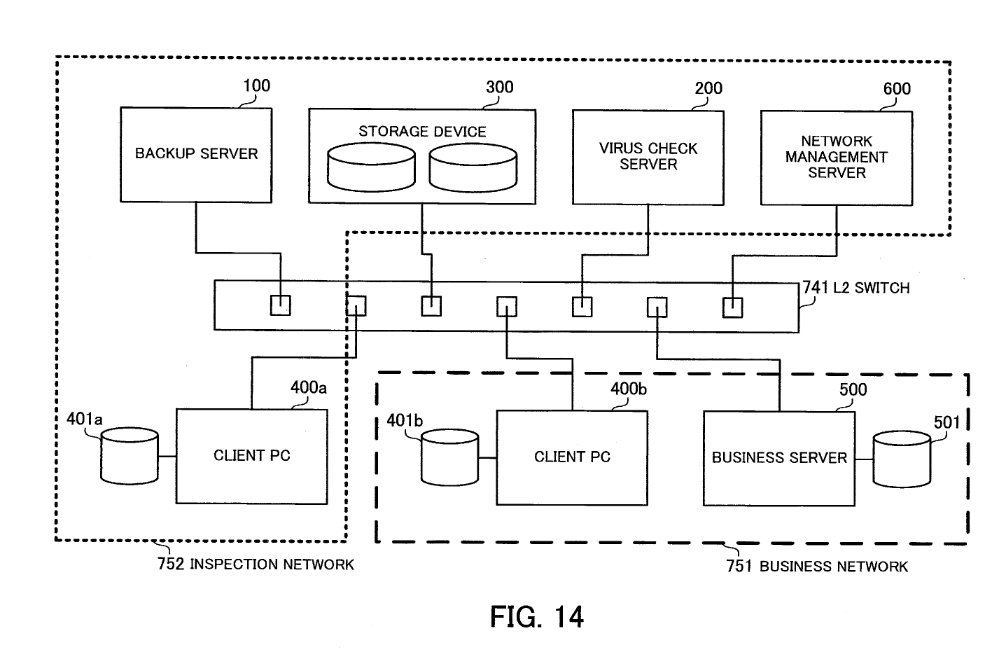

FIG. 14 illustrates an example configuration of an information processing system according to a third embodiment. In FIG. 14, same parts are identified with same reference numerals as in FIG. 2, and will not be described again.

In the above second embodiment, apparatuses are connected to each other via the business network 710, the storage area network 720, and the inspection network 730. Alternatively, these apparatuses may be connected to each other via one network. For example, the apparatuses are connected to each other via an L2 switch 741, as illustrated in FIG. 14. FIG. 14 illustrates an example where a plurality of client PCs 400a and 400b are connected to each other. These client PCs 400a and 400b have the same configuration and functions as the client PC 400 illustrated in FIG. 2.

In this configuration, for example, in the case where a computer virus is detected in backup data of one client PC, a network to which this client PC belongs may be logically isolated from a network to which the other client PC belongs. This operation is realized by using the Virtual LAN (VLAN) functions of the L2 switch 741.

For example, in a normal state where no computer virus is detected, all apparatuses illustrated in FIG. 14 belong to a business network 751 which is a network group usually used. In addition, a backup server 100, virus check server 200, storage device 300, and network management server 600 also belong to an inspection network 752. In this connection, at least one of the virus check server 200, storage device 300, and network management server 600 may not belong to the business network 751.

When a computer virus is detected in an image file corresponding to the client PC 400a, the virus check server 200 requests the network management server 600 to disconnect the client PC 400a from the business network 751. The network management server 600 controls the L2 switch 741 so as to connect the client PC 400a to the inspection network 752 instead of the business network 751.

Then, after a restore process is completed in the client PC 400a, the network management server 600 reconnects the client PC 400a to the business network 751 in response to a request from the backup server 100.

This operation prevents computer virus from spreading to apparatuses belonging to the business network 751.

(Fourth Embodiment)

In the above second and third embodiments, the backup function, the virus check and removal function, and the network switch control function are realized by different servers. Alternatively, the virus check and removal function that the virus check server 200 has may be realized by the backup server 100. In addition, the network switch control function that the network management server 600 has may also be realized by the backup server 100. This embodiment exemplifies the case where the backup server is provided with all of these functions.

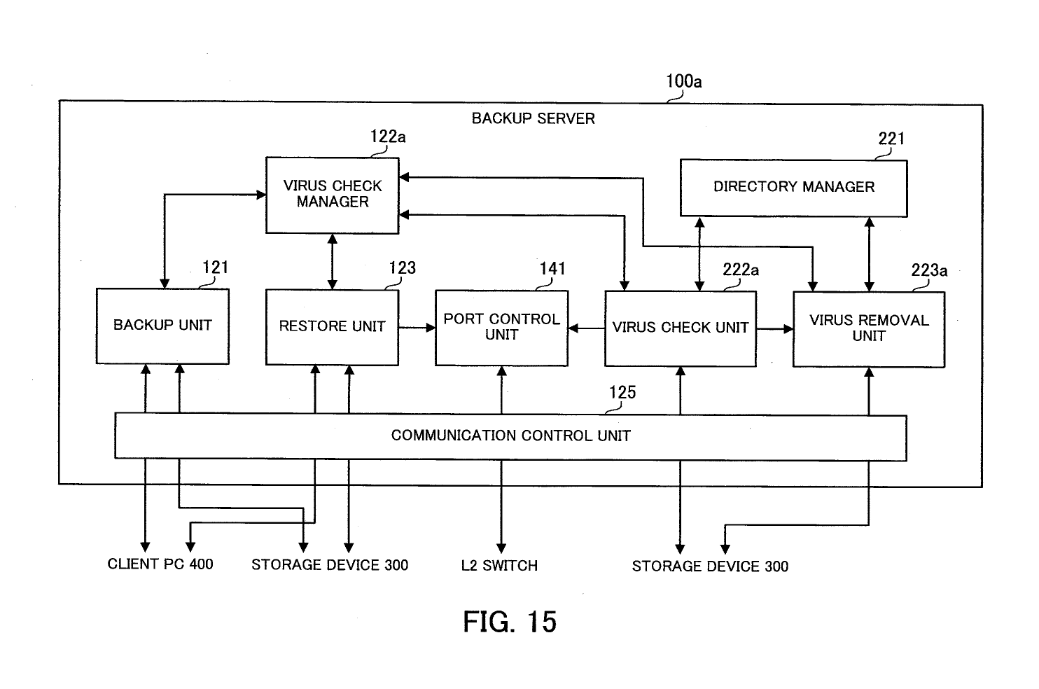

FIG. 15 is a functional block diagram of a backup server according to the fourth embodiment. In FIG. 15, same parts are identified with same reference numerals as in FIGS. 5 and 7, and will not be described again.

In the illustrated backup server 100a, the basic functions of a virus check manager 122a are the same as those of the virus check manager 122 of FIG. 5. In addition, the basic functions of a virus check unit 222a and virus removal unit 223a are the same as those of the virus check unit 222 and virus removal unit 223 of FIG. 7, respectively, except that the virus check manager 122a communicates with the virus check unit 222a and the virus removal unit 223a directly, not via a network.

In addition, a port control unit 141 is designed to be able to directly control the switching operation of an L2 switch (not illustrated) on the network in response to a request from a restore unit 123 and the virus check unit 222a. For example, when a computer virus is detected, the virus check unit 222a requests the port control unit 141 to disconnect a corresponding client PC from the network. In response to this request, the port control unit 141 closes the port of the L2 switch connected to the corresponding client PC out of the connection ports thereof. In addition, when the restore process is completed, the restore unit 123 requests the port control unit 141 to reconnect the corresponding client PC to the network. The port control unit 141 opens the specified port of the L2 switch in response to this request, thereby reconnecting the client PC to the network.

The fourth embodiment provides the same effects as the above-described second and third embodiments.

The above processing functions of the apparatuses (for example, backup server, virus check server, network management server, and client PC) provided in the above embodiments are realized by using a computer. In this case, a program is prepared, which describes the processing contents of the functions. The above processing functions are realized on the computer by executing the program. The program describing the needed processes may be recorded on a computer-readable storage medium. Computer-readable storage media include magnetic storage devices, optical discs, magneto-optical storage media, semiconductor memories, etc.

To distribute the program, portable storage media, such as optical discs, on which the program is recorded may be put on sale. Alternatively, the program may be stored in the storage device of a server computer and may be transferred from the server computer to other computers through a network.

A computer which is to execute the above program stores in its local storage device the program recorded on a portable storage medium or transferred from the server computer, for example. Then, the computer reads the program from the local storage device, and runs the program. The computer may run the program directly from the portable storage medium. Also, while receiving the program being transferred from the server computer, the computer may sequentially run this program.

The disclosed information processing system and management apparatus make it possible to efficiently and reliably perform a backup process and virus detection and removal process on data stored in a protected storage device connected to a protected information processing apparatus.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. An information processing system comprising:
a management apparatus that includes:
a backup unit to read all data from a protected storage device connected to a protected information processing apparatus, and store the read all data as one image file in a backup storage device,
a virus detection request unit to make a request for performing a virus detection process on the image file stored in the backup storage device, and
a restore unit to read and write the image file from the backup storage device back to the protected storage device upon reception of a completion notification of a virus removal process that is performed on the image file when a computer virus is detected in the image file by the virus detection process performed in response to the request; and
a virus detection apparatus that includes:
a virus detection unit to perform the virus detection process on the image file stored in the backup storage device in response to the request from the virus detection request unit, and
a virus removal unit to perform the virus removal process on the image file when the computer virus is detected in the image file, and output the completion notification to the restore unit after completing the virus removal process.

2. The information processing system according to claim 1, further comprising:
a plurality of the protected information processing apparatuses connected via a network, wherein:
the virus detection apparatus further includes a disconnection request unit to request a network control apparatus to physically or logically isolate the protected information processing apparatus corresponding to the image file from other protected information processing apparatuses when the computer virus is detected in the image file by the virus detection unit, the network control apparatus controlling connections of apparatuses to the network; and
the management apparatus further includes a reconnection request unit to request the network control apparatus to reconnect the protected information processing apparatus corresponding to the image file to the network after the restore unit writes the image file back to the protected storage device.

3. The information processing system according to claim 1, further comprising:
a plurality of the protected information processing apparatuses connected via a network,
wherein the management apparatus further includes:
a disconnection request unit to request a network control apparatus to physically or logically isolate the protected information processing apparatus corresponding to the image file from other protected information processing apparatuses when the computer virus is detected in the image file by the virus detection unit, the network control apparatus controlling connections of apparatuses to the network; and
a reconnection request unit to request the network control apparatus to reconnect the protected information processing apparatus corresponding to the image file to the network after the restore unit writes the image file back to the protected storage device.

4. The information processing system according to claim 1, wherein upon receipt of the request for performing the virus detection process from the virus detection request unit, the virus detection unit mounts a storage region storing the image file of the backup storage device as a logical volume of the virus detection apparatus, and performs the virus detection process on the logical volume.

5. The information processing system according to claim 1, wherein the backup unit acquires the all data from the protected storage device by sending the protected information processing apparatus a reading program for reading and sending the all data from the protected storage device to the management apparatus, and causing the protected information processing apparatus to execute the reading program.

6. The information processing system according to claim 1, wherein the restore unit writes the image file back to the protected storage device by sending the protected information processing apparatus a writing program for receiving the image file cleaned by the virus removal process from the management apparatus and writing the image file back to the protected storage device, and causing the protected information processing apparatus to execute the writing program.

7. The information processing system according to claim 6, wherein:
the management apparatus further includes a shutdown request unit to shut down the protected information processing apparatus corresponding to the image file when the computer virus is detected in the image file by the virus detection process performed by the virus detection unit; and
the restore unit sends a wakeup request to the protected information processing apparatus that is shut down to turn on the protected information processing apparatus, sends a program of an operating system for restore to the protected information processing apparatus to install the program in the protected information processing apparatus, and then sends the writing program to the protected information processing apparatus to execute the writing program on the operating system.

8. A management apparatus comprising:
a backup unit that reads all data from a protected storage device connected to a protected information processing apparatus, and stores the read all data as one image file in a backup storage device;
a virus detection request unit that requests a virus detection apparatus to perform a virus detection process on the image file stored in the backup storage device; and
a restore unit that reads and writes the image file from the backup storage device back to the protected storage device upon receipt of a completion notification of a virus removal process from the virus detection apparatus, the virus removal process being performed on the image file when a computer virus is detected in the image file by the virus detection process performed in response to the request.

9. A management apparatus comprising:
a backup unit that reads all data from a protected storage device connected to a protected information processing apparatus, and stores the read all data as one image file in a backup storage device;
a virus detection unit that performs a virus detection process on the image file stored in the backup storage device;
a virus removal unit that performs a virus removal process on the image file when a computer virus is detected in the image file; and
a restore unit that reads and writes the image file cleaned by the virus removal process from the backup storage device back to the protected storage device after the virus removal unit completes the virus removal process.

10. An information processing method comprising:
reading, by a management apparatus, all data from a protected storage device connected to a protected information processing apparatus, and storing the read all data as one image file in a backup storage device;
requesting, by the management apparatus, a virus detection apparatus to perform a virus detection process on the image file stored in the backup storage device;
performing, by the virus detection apparatus, the virus detection process on the image file stored in the backup storage device in response to a request from the management apparatus;
performing, by the virus detection apparatus, a virus removal process on the image file when a computer virus is detected in the image file, and outputting a completion notification to the management apparatus after completing the virus removal process;
reading and writing, by the management apparatus, the image file from the backup storage device back to the protected storage device upon receipt of the completion notification of the virus removal process performed on the image file.

11. An information processing method to be executed by a computer, the method comprising a procedure of:
reading all data from a protected storage device connected to a protected information processing apparatus, and storing the read all data as one image file in a backup storage device;
performing a virus detection process on the image file stored in the backup storage device;
performing a virus removal process on the image file when a computer virus is detected in the image file; and
reading and writing the image file from the backup storage device back to the protected storage device after a virus removal process is performed on the image file.
